(19) United States
(12) Patent Application Publication
(10) Pub. No.: US 2024/0164385 A1
(43) Pub. Date: May 23, 2024

(54) A SYNERGISTIC PLANT GROWTH STIMULANT COMPOSITION COMPRISING POTASSIUM MONO/DIFORMATE AND METAL ION COMPOUNDS TO ENHANCED METABOLIC ACTIVITIES IN PLANTS

(71) Applicant: FERTIS INDIA PVT LTD, Hyderabad (IN)

(72) Inventors: Rahul Raju KANUMURU, Hyderabad (IN); George Kochumalayil SHAJI, Hyderabad (IN); Lakshmi Prasanna Kumar GARUDADRI, Hyderabad (IN); Ravikumar SURANENI, Hyderabad (IN); Sil ANINDYA, Hyderabad (IN)

(21) Appl. No.: 18/551,835

(22) PCT Filed: Mar. 30, 2022
(86) PCT No.: PCT/IN2022/050321

§ 371 Date: Sep. 21, 2023

(30) Foreign Application Priority Data
Mar. 31, 2021 (IN) 202141015142

(51) Int. Cl. A01N 59/00; A01N 37/02; A01N 37/10; A01N 43/12; A01N 43/38; A01N 59/12; A01N 59/16; A01N 59/20; A01P 21/00

(52) U.S. Cl. CPC A01N 59/00; A01N 37/02; A01N 37/10; A01N 43/12; A01N 43/38; A01N 59/12; A01N 59/16; A01N 59/20; A01P 21/00

(57) ABSTRACT

The invention disclosed herein is a synergistic plant growth stimulant composition comprising potassium mono/di-formate and metal ion compounds to improve the catalytic activity of metalloenzymes which result in enhanced metabolic activities in plant system thereby providing high yields and quality produce. The invention also disclosed herein is a process for preparation of said synergistic composition.

### TECHNICAL FIELD OF THE INVENTION

The present invention relates to a synergistic plant growth stimulant composition comprising potassium mono/di-formate and metal ion compounds to improve the catalytic activity of metalloenzymes resulting into enhanced metabolic activities in plant system. The present invention also relates to a process for preparation of said composition.

### BACKGROUND AND PRIOR ART OF THE INVENTION

Plant metabolism is a complex of physical and chemical events of photosynthesis, respiration, and the synthesis and degradation of organic compounds. Photosynthesis produces the substrates for respiration and the starting organic compounds used as building blocks for subsequent biosynthesis of nucleic acids, amino acids, and proteins, carbohydrates and organic acids, lipids, and natural products. Plant secondary metabolism produces products that aid in the growth and development of plants but are not required for the plant to survive. Secondary metabolism facilitates the primary metabolism in plants. This primary metabolism consists of chemical reactions that allow the plant to live. In order for the plants to stay healthy, secondary metabolism plays a pinnacle role in keeping all the of plants systems working properly. A common role of secondary metabolites in plants is defense mechanisms. They are used to fight off herbivores, pests, and pathogens. Secondary metabolites are used in anti-feeding activity, toxicity or acting as precursors to physical defense systems. Primary metabolism in a plant comprises all metabolic pathways that are essential to the plant's survival. Primary metabolites are compounds that are directly involved in the growth and development of a plant whereas secondary metabolites are compounds produced in other metabolic pathways that, although important, are not essential to the functioning of the plant. However, secondary plant metabolites are useful in the long term, often for defense purposes, and give plants characteristics such as color. Secondary plant metabolites are also used in signaling and regulation of primary metabolic pathways. Plant hormones, which are secondary metabolites, are often used to regulate the metabolic activity within cells and oversee the overall development of the plantⁱ.

Potassium is vital to many plant processes. Potassium determines fruit size, leaf thickness, and stem strength. Potassium also plays a major role as a catalyst in the plant sap and transports carbohydrates from leaves to other parts of the plant, including the fruit. Crops which produce large amounts of sugars have an especially high requirement for potassium. Potassium is required for numerous plant growth processes: enzyme activation, stomatal activity (water use), photosynthesis, transport of sugars, water and nutrient transport, protein synthesis and starch synthesis. In general, Potassium helps to increase crop yield and improve crop quality because it increases root growth and improves drought resistance, and activates many enzyme systemsⁱⁱ.

The metal ions such as cobalt (Co), copper (Cu), iron (Fe), manganese (Mn), molybdenum (Mo), nickel (Ni) and zinc (Zn) plays a beneficial role for plant growth, development and productivity in the form of essential micronutrient. To grow and complete the life cycle, plants use these essential micronutrients. The plant takes the essential metals like iron, zinc, copper and manganese from the soil due to concentration gradients and selective uptake of these metals. These ions enthusiastically affected the function of many enzymes and cellular metabolism. These metals also play a prominent role in the synthesis of protein, nucleic acids, photosynthetic pigment and it also take part in the structural and functional integrity of cell membranes. These important metal ions also plays essential role in plants for example Copper is an essential heavy metal which actively takes part in the photosynthesis, Manganese is an important constituent of various metabolic enzyme like mallic dehydrogenase and oxalosuccinic decarboxylase, Cobalt found in the form of Vitmain B12, while Fe act as a cofactor in cytochromeⁱⁱⁱ.

Metalloenzymes are enzyme proteins containing metal ions (metal cofactors), which are directly bound to the protein or to enzyme-bound non-protein components (prosthetic groups). These proteins are involved in many physiological pathways of plants.

While researching for the effective solution for the enhanced metabolic activities in plant system, the inventors found that, there has been not much work done on the combination of potassium formate and metal ions. It is known that the potassium formate destroys the pathogenic bacteria and enhances the activity of beneficial bacteria. Hence, the present inventors has combine the potassium formate and metal ion compounds and develop a synergistic composition that improves the catalytic activity of metalloenzymes (found in symbiotic bacteria) which results into enhanced metabolic activities in plant system.

The present synergistic composition comprising combination of potassium formate and metal ion compounds provides very strong anti-microbial property along with enhancement of enzyme in plant metabolism as metalloenzyme combination. The said composition also provides abiotic and biotic stress tolerance to the plant system and is very effective in agriculture applications to improve the efficacy.

### SUMMARY OF THE INVENTION

In accordance with the above, in a preferred aspect, the present invention describes a synergistic plant growth stimulant composition comprising potassium formate and metal ion compounds selected from metal oxides or metal salts to improve the catalytic activity of metalloenzymes which result in enhanced metabolic activities in plant system thereby providing high yields and quality produce.

In another preferred aspect, the present invention describes a synergistic plant growth stimulant composition comprising (a) potassium formate selected from mono or diformate and (b) metal ion compounds selected from metal oxides or metal salts, optionally in combination with primary or secondary nutrients and plant growth hormones, to improve the catalytic activity of metalloenzymes which result in enhanced metabolic activities in plant system thereby providing high yields and quality produce.

In another preferred aspect, the present invention disclose a synergistic plant growth stimulant composition comprising (a) potassium mono or diformate (b) calcium formate and boric acid and (c) metal ion compounds selected from metal oxides or metal salts, optionally in combination with primary or secondary nutrients and plant growth hormones, to improve the catalytic activity of metalloenzymes which result in enhanced metabolic activities in plant system thereby providing high quality of fruits and high yields.

In another preferred aspect, the present invention describes a synergistic plant growth stimulant composition comprising potassium mono or diformate and metal ion compounds selected from metal oxides or metal salts that improve the catalytic activity of metalloenzymes which result in enhanced metabolic activities in plant system thereby providing high yields and quality produce, when compare with individual application of potassium mono or diformate and metal ion compounds.

In another preferred aspect, the present invention describes a process for preparation of said synergistic plant growth stimulant composition potassium mono or diformate and metal ion compounds.

In yet another preferred aspect, the present invention describes a method of improving the catalytic activity of metalloenzymes, results in enhanced metabolic activities in plant system by applying synergistic plant growth stimulant composition comprising potassium mono or diformate and metal ion compounds on plants.

### BRIEF DESCRIPTION OF FIGURES

FIG. 1: Comparison of Absorption of micronutrients (in ppm) between composition comprising potassium mono or diformate and metal ion compounds Vs. individual potassium formate, individual potassium diformate, micronutrients and control.

FIG. 2: Comparison of Total Phenol content (in ppm) between composition comprising potassium mono or diformate and metal ion compounds Vs. individual potassium formate, individual potassium diformate, micronutrients and control.

FIG. 3: Comparison of % of total protein between composition comprising potassium mono or diformate and metal ion compounds Vs. individual potassium formate, individual potassium diformate, micronutrients and control.

### DETAILED DESCRIPTION OF THE INVENTION

The invention will now be described in detail in connection with certain preferred and optional embodiments, so that various aspects thereof may be more fully understood and appreciated.

The potassium formate, metal ion compounds, primary or secondary nutrients and plant growth hormones used in present composition are commercially procured or synthetically manufactured.

The present invention discloses a synergistic plant growth stimulant composition comprising potassium formate selected from mono or diformate and at least one metal compound in the form of metal oxide/ion or metal salts/complex to improve the catalytic activity of metalloenzymes which result in enhanced metabolic activities in plant system thereby providing high yields and quality produce.

The metal ion compounds used in the present synergistic composition are selected from metal oxides/ions such as Copper (Cu²⁺), Zinc (Zn²⁺), Cobalt (Co²⁺), Nickel (Ni²⁺), Manganese (Mn²⁺), Molybdenum (Mo²⁺), Ferric/Ferrous (Fe^{3+/2+}), Selenium (Se⁴⁺) and the like, either alone or in combination thereof.

The metal ion compounds used in the present synergistic composition are selected from metal salts/complex such as calcium, potassium, copper, cobalt, zinc, iron, boron, manganese, magnesium, nickel, selenium, molybdenum, iodine, Copper sulphate pentahydrate, Zinc sulphate monohydrate, Ferrous sulphate heptahydrate, Manganese sulphate monohydrate, Magnesium sulphate anhydrous, Nickel Sulphate hexahydrate, Cobalt sulphate heptahydrate and Potassium iodide.

The amount of potassium mono or diformate used in the present synergistic composition ranges from 1 to 20% of total composition.

The amount of metal ion compounds used in the present synergistic composition ranges from 0.1 to 50%, preferably, 1 to 20% of the total composition.

The ratio of potassium mono or diformate and metal ion compounds in the present synergistic composition varies from 1:0.05 or 1:0.5 or 1:1.

In another embodiment, the present invention disclose a synergistic plant growth stimulant composition comprising potassium mono or diformate and metal ion compounds selected from metal oxides or metal salts optionally in combination with primary or secondary nutrients and plant growth hormones, to improve the catalytic activity of metalloenzymes which result in enhanced metabolic activities in plant system thereby providing high yields and quality produce.

The primary nutrients are selected from nitrogen, phosphorous or potassium and secondary nutrients are selected from silica, calcium, magnesium or sulphur, either alone or in combination thereof.

The amount of primary or secondary nutrients used in the present synergistic composition ranges from 0.1 to 50% of the total composition.

The plant growth hormones are selected from Gibberellic acid, melatonin, abscisic acid either alone or in combination thereof.

The amount of plant growth hormones used in the present synergistic composition ranges from 0.05 to 10% of the total composition.

In another preferred embodiment, the present invention disclose a synergistic plant growth stimulant composition comprising (a) potassium mono or diformate (b) calcium formate and boric acid and (c) metal ion compounds selected from metal oxides or metal salts optionally in combination with primary or secondary nutrients and plant growth hormones, to improve the catalytic activity of metalloenzymes which result in enhanced metabolic activities in plant system thereby providing high quality of fruits and high yields.

The amount of calcium formate and boric acid used in the present synergistic composition ranges from 125 to 500 gm of the total composition. The calcium formate and boric acid improves the quality of fruits and end produce.

In another embodiment, a synergistic plant growth stimulant composition of the present invention further comprises iodine, hormones, additional nutritional products, growth stimulation agents, nitrogenous compounds with minerals, and minerals and trace metals.

The iodine is in a ratio ranging from 0.05 to 0.1 of the total composition.

The hormones selected from auxin, cytokinin, gibberellic acid, brassinosteroids, ethylene, abscisic acid, salicylic acid and Jasmonic acid; and are present in a concentration ranging from 0.05% to 10%.

The additional nutritional products and/or growth stimulation agents are selected from amino acid powders, and essential oils and are present in a concentration ranging from 0.1 to 5%.

The minerals and trace metals such as Zn, Cu, Mn, Fe, Co, Ca, Mg, Mn; and are present in the range of about 400 g/acre to 3000 g/acre.

In another embodiment, a synergistic plant growth stimulant composition of the present invention optionally comprises additional inert ingredients such as adjuvants, emulsifiers, thickeners, suspension agents, wetting agents, surfactant and filler and aqua filler material. Sodium ligno sulfonates, CMc etc

The adjuvants, emulsifiers, thickeners, suspension agents, wetting agents are present in an amount of 0.1 to 10% of the total composition.

The surfactant selected from anionic, non-ionic and cationic surfactants viz., carboxy methyl cellulose (CMC), lignosulfonates and is present in an amount of 0.1 to 10% of total composition.

The filler material such as bentonite or dolomite and aqua fillers such as water, polysorbate, tween 80, tween-20, other surfactants.

The adjuvants/surfactants used in the present composition ensure uniform and wide spreading of the composition on the plant when applied, to give complete application of foliage by maintaining surface tension of leaf and molecule contact to the plant.

In another embodiment, a synergistic plant growth stimulant composition of the present inventions optionally comprises an antioxidant such as sodium nitroprusside which enhances the nitrogen use efficiency of the crop and provides antioxidant property to the crop. The ratio of composition comprises (a) potassium mono or diformate and (b) sodium nitroprusside ranges from 1:0.25 to 1:25.

In one preferred embodiment, the present invention provides a synergistic plant growth stimulant composition comprising potassium mono or diformate and metal ion compounds in a ratio varies from 1:0.05, 1:0.5 or 1:1 along with inert excipients such as an adjuvants and/or surfactant in an amount of 3 to 20%, to improve the catalytic activity of metalloenzymes which result in enhanced metabolic activities in plant system thereby providing high yields and quality produce.

In yet another preferred embodiment, the present invention provides a synergistic plant growth stimulant composition comprising potassium mono or diformate and metal ion compounds that the catalytic activity of metalloenzymes which result in enhanced metabolic activities in plant system thereby providing high yields and quality produce, when compare with individual application of potassium mono/diformate and metal ion compounds.

In another preferred embodiment, the present invention provides a process for preparation of said synergistic plant growth stimulant composition comprising potassium mono or diformate and metal ion compounds comprising;
a) blending the active ingredients and adding surfactant and adjuvants to obtain powder form.
b) mixing aqua filler with active ingredients to obtain liquid form.
c) granulating the active ingredients with filler material such as bentonite or dolomite to obtain granule form.
d) the powder, liquid or granule form obtained in above step (a), (b) or (c) dissolve in water and apply on crops.

In another preferred embodiment, the present invention provides a method of improving the catalytic activity of metaloenzymes, results in enhanced metabolic activities in plant system by spraying synergistic plant growth stimulant composition comprising potassium mono or diformate and metal ion compounds on leaves as foliar application or by mixing in soil as fertilizer application.

In yet another embodiment, the present invention provides a synergistic effect of plant growth stimulant composition comprising potassium mono or diformate and metal ion compounds; wherein the amount of said composition applied/sprayed on leaves as foliar application at a concentration ranging from 0.1 to 500 g/L or by mixing in soil as fertilizer application in a concentration ranging from 2 g/acre to 10 g/acre.

In yet another preferred embodiment, the present invention provides a synergistic effect of plant growth stimulant composition comprising potassium mono or diformate and metal ion compounds, when compare with individual application of potassium mono or diformate and metal ion compounds, for improving the catalytic activity of metalloenzymes which result in enhanced metabolic activities in plant system thereby providing high yields and quality produce.

The present synergistic composition comprising combination of potassium mono/diformate and metal ion compounds improves the catalytic activity of metalloenzymes (found in symbiotic bacteria) which results into enhanced metabolic activities in plant system. The present synergistic composition provides very strong anti-microbial property along with enhancement of enzyme in plant metabolism as metalloenzyme combination. The said composition also provides abiotic and biotic stress tolerance to the plant system and is very effective in agriculture applications to improve the efficacy.

In another embodiment, a synergistic plant growth stimulant composition of the present invention comprising potassium mono or diformate and metal ion compounds can be formulated in the form of powder, liquid, solutions, spray, gel or granules.

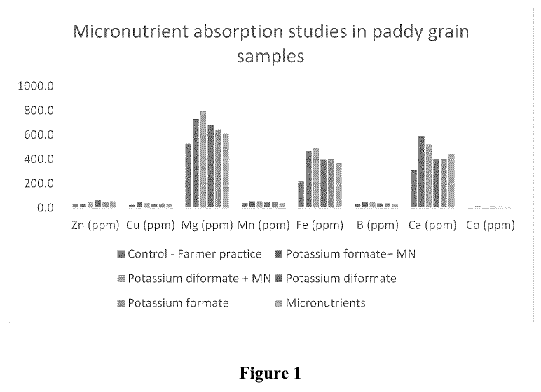

In yet another embodiment, the present invention discloses that a synergistic plant growth stimulant composition comprising potassium mono or diformate and metal ion compounds exhibits presence of higher amount of micronutrients, Phenol content and total protein content in plant as compared to individual potassium formate (mono and di), individual metal ions/micronutrients and control. The same is depicted in below Examples 8 to 11, Table A to C and FIGS. 1 to 3.

Some typical examples illustrating the embodiments of the present invention are provided; however, these examples are exemplary only and should not be regarded as limiting the elements of the present invention.

### EXAMPLES

### Example 1: Composition 1 Comprising Potassium Mono/Diformate with Metal Ion Compounds

| Sr. | | Quantity |
|---|---|---|
| No. | Ingredients | (gm/acre) |
| 1. | Potassium formate | 200 |
| 2. | Calcium formate and boric acid | 250 |
| 3. | Copper sulphate pentahydrate | 2.25 |
| 4. | Zinc sulphate monohydrate | 100 |
| 5. | Ferrous sulphate heptahydrate | 100 |
| 6. | Manganese sulphate monohydrate | 100 |
| 7. | Magnesium sulphate anhydrous | 50 |
| 8. | Nickel Sulphate hexahydrate | 20 |
| 9. | Cobalt sulphate heptahydrate | 20 |
| 10. | Potassium iodide | 3 |
| 11. | Adjuvants | 7 |
| 12. | Water | Q.S. |

| | |
|---|---|
| Total weight in gm | 1000 |

### Example 2: Composition 2 Comprising Potassium Mono/Diformate with Metal Ion Compounds

| Sr. | | Quantity |
|---|---|---|
| No. | Ingredients | (gm/acre) |
| 1. | Potassium formate | 100 |
| 2. | Calcium formate and boric acid | 125 |
| 3. | Copper sulphate pentahydrate | 1.125 |
| 4. | Zinc sulphate monohydrate | 50 |
| 5. | Ferrous sulphate heptahydrate | 50 |
| 6. | Manganese sulphate monohydrate | 50 |
| 7. | Magnesium sulphate anhydrous | 25 |
| 8. | Nickel Sulphate hexahydrate | 10 |
| 9. | Cobalt sulphate heptahydrate | 10 |
| 10. | Potassium iodide | 1.5 |
| 11. | Adjuvants | 3.5 |
| 12. | Water | Q.S. |

| | |
|---|---|
| Total weight in gm | 500 |

### Example 3: Composition 3 Comprising Potassium Mono/Diformate with Metal Ion Compounds

| Sr. | | Quantity |
|---|---|---|
| No. | Ingredients | (gm/acre) |
| 1. | Potassium formate | 400 |
| 2. | Calcium formate and boric acid | 500 |
| 3. | Copper sulphate pentahydrate | 4.5 |
| 4. | Zinc sulphate monohydrate | 200 |
| 5. | Ferrous sulphate heptahydrate | 200 |
| 6. | Manganese sulphate monohydrate | 200 |
| 7. | Magnesium sulphate anhydrous | 100 |
| 8. | Nickel Sulphate hexahydrate | 40 |
| 9. | Cobalt sulphate heptahydrate | 40 |
| 10. | Potassium iodide | 6 |
| 11. | Adjuvants | 14 |
| 12. | Water | Q.S. |

| | |
|---|---|
| Total weight in gm | 2000 |

### Example 4: Composition 4 Comprising Potassium Mono/Diformate with Metal Ion Compounds and Plant Growth Hormones

| Sr. | | Quantity |
|---|---|---|
| No. | Ingredients | (gm/acre) |
| 1. | Potassium formate | 200 |
| 2. | Calcium formate and boric acid | 250 |
| 3. | Copper sulphate pentahydrate | 2.25 |
| 4. | Zinc sulphate monohydrate | 100 |
| 5. | Ferrous sulphate heptahydrate | 100 |
| 6. | Manganese sulphate monohydrate | 100 |
| 7. | Magnesium sulphate anhydrous | 50 |
| 8. | Nickel Sulphate hexahydrate | 20 |
| 9. | Cobalt sulphate heptahydrate | 20 |
| 10. | Potassium iodide | 3 |
| 11. | Gibberellic acid | 2 |
| 12. | Melatonin | 2.25 |
| 13. | Abscisic acid | 1 |
| 14. | Adjuvants | 10 |
| 15. | Water | Q.S. |

| | |
|---|---|
| Total weight in gm | 1000 |

### Example 5: Composition 5 Comprising Potassium Mono/Diformate with Metal Ion Compounds and Plant Growth Hormones

| Sr. | | Quantity |
|---|---|---|
| No. | Ingredients | (gm/acre) |
| 1. | Potassium formate | 100 |
| 2. | Calcium formate and boric acid | 125 |
| 3. | Copper sulphate pentahydrate | 1.125 |
| 4. | Zinc sulphate monohydrate | 50 |
| 5. | Ferrous sulphate heptahydrate | 50 |
| 6. | Manganese sulphate monohydrate | 50 |
| 7. | Magnesium sulphate anhydrous | 25 |
| 8. | Nickel Sulphate hexahydrate | 10 |
| 9. | Cobalt sulphate heptahydrate | 10 |
| 10. | Potassium iodide | 1.5 |
| 11. | Gibberellic acid | 1 |
| 12. | Melatonin | 1.125 |
| 13. | Abscisic acid | 0.5 |
| 14. | Adjuvants | 5 |
| 15. | Water | Q.S. |

| | |
|---|---|
| Total weight in gm | 500 |

### Example 6: Composition 6 Comprising Potassium Mono/Diformate with Metal Ion Compounds and Plant Growth Hormones

| Sr. | | Quantity |
|---|---|---|
| No. | Ingredients | (gm/acre) |
| 1. | Potassium formate | 400 |
| 2. | Calcium formate and boric acid | 500 |
| 3. | Copper sulphate pentahydrate | 4.5 |
| 4. | Zinc sulphate monohydrate | 200 |
| 5. | Ferrous sulphate heptahydrate | 200 |
| 6. | Manganese sulphate monohydrate | 200 |
| 7. | Magnesium sulphate anhydrous | 100 |
| 8. | Nickel Sulphate hexahydrate | 40 |
| 9. | Cobalt sulphate heptahydrate | 40 |
| 10. | Potassium iodide | 6 |
| 11. | Gibberellic acid | 4 |
| 12. | Melatonin | 4.5 |
| 13. | Abscisic acid | 2 |
| 14. | Adjuvants | 20 |
| 15. | Water | Q.S. |

| | |
|---|---|
| Total weight in gm | 2000 |

### Example 7: Composition 7 Comprising Potassium Mono/Diformate with Metal Ion Compounds and Antioxidants

| Sr. | | Quantity |
|---|---|---|
| No. | Ingredients | (gm/acre) |
| 1. | Potassium formate | 100 |
| 2. | Calcium formate and boric acid | 125 |
| 3. | Copper sulphate pentahydrate | 1.125 |
| 4. | Zinc sulphate monohydrate | 50 |
| 5. | Ferrous sulphate heptahydrate | 50 |
| 6. | Manganese sulphate monohydrate | 50 |
| 7. | Magnesium sulphate anhydrous | 25 |
| 8. | Nickel Sulphate hexahydrate | 10 |
| 9. | Cobalt sulphate heptahydrate | 10 |
| 10. | Potassium iodide | 1.5 |
| 11. | Sodium nitroprusside | 20 |
| 12. | Adjuvants | 3.5 |
| 13. | Water | Q.S. |

| | |
|---|---|
| Total weight in gm | 520 |

### Example 8: Process for Preparation of Composition

a) blending 100 gm of active ingredients and adding 10 gm of surfactant and adjuvants to obtain powder form.
b) mixing 100 gm of aqua filler with 10 gm of active ingredients to obtain liquid form.
c) granulating 900 gm of active ingredients with 100 gm of filler material to obtain granule form.
d) the powder, liquid or granule form obtained in above step (a), (b) or (c) dissolve in water and apply on crops.

### Experimental Examples

### Example 9: Analysis of Micronutrient Absorption Levels in Paddy Grains

### Analysis of Micronutrients in Paddy Samples by ICP (Inductive Coupled Plasma) Equipment.

### Sample Preparation:

i. 1 gm of grain powder added to 60 ml of perchloric acid and Nitric acid (9:1) digest for overnight.
ii. Heat at 100° C. for 2 hours until vapors change from red to white color.
iii. The resultant solution filtered through Whatman paper and makeup to 100 ml with 1% nitric acid.

The solution will test for micronutrient by ICP and results as follows:

TABLE A
Micronutrient absorption studies in paddy grain samples

| | | Zn | Cu | Mg | Mn | Fe | B | Ca | Co |
|---|---|---|---|---|---|---|---|---|---|
| Sr. | Sample | (Zinc) | (Copper) | (Magnesium) | (Manganese) | (Iron) | (Boron) | (Calcium) | (Cobalt) |
| No. | Name | (ppm) | (ppm) | (ppm) | (ppm) | (ppm) | (ppm) | (ppm) | (ppm) |
| 1. | Control— | 28.0 | 23.78 | 530.0 | 38.0 | 216.9 | 29.0 | 311.8 | 13.0 |
| | Farmer | | | | | | | | |
| | Practice* | | | | | | | | |
| 2. | Potassium | 34.7 | 46.0 | 731.0 | 54.1 | 465.0 | 49.6 | 589.0 | 14.0 |
| | formate + | | | | | | | | |
| | MN | | | | | | | | |
| 3. | Potassium | 44.9 | 41.0 | 798.0 | 56.2 | 493.0 | 46.2 | 522.0 | 14.0 |
| | diformate + | | | | | | | | |
| | MN | | | | | | | | |
| 4. | Potassium | 66.6 | 35.0 | 678.0 | 50.4 | 397.0 | 35.9 | 399.0 | 14.2 |
| | diformate | | | | | | | | |
| 5. | Potassium | 50.6 | 37.0 | 646.0 | 46.5 | 401.0 | 38.4 | 401.7 | 14.2 |
| | formate | | | | | | | | |
| 6. | Micro- | 55.3 | 31.0 | 613.0 | 41.2 | 369.0 | 36.9 | 444.0 | 14.2 |
| | nutrients | | | | | | | | |
| | (MN) | | | | | | | | |

*Farmer Practice—All kinds of N, P, K fertilizers and supplements
MN—Micronutrient

The values achieved in above table also demonstrated in the form of Figure. It is clear from above Table A and FIG. 1 provided below that the Composition comprising potassium formate (mono or di) and metal ions exhibits presence of higher amount of micronutrients viz., Cu, Mg, Mn, Fe, B and Ca as compare to individual potassium formate (mono and di), individual metal ions/micronutrients and control.

### Example 10: Estimation of Total Phenol Content

### Gallic Acid Standard Preparation:

Gallic acid: Take 100 mg of gallic acid in 100 ml of volumetric flask and then make up to mark with distilled water (or) milli Q water
We take 5 volumetric flask then to the above solution we add each of 1 ml/100 ml (10 ppm), 2 ml/100 ml (20 ppm), 3 ml/100 ml (30 ppm), 4 ml/100 ml (40 ppm), 5 ml/100 ml (50 ppm) and make up to mark with distilled water.

### Folin-Ciocalteu's Phenol Reagent Preparation:

Take 5 ml of folin ciocalteu's phenol reagent in 50 ml of volumetric flask and then make up to the mark with distilled water

7.5% of Na₂CO₃ Preparation:

Take 7.5 g of Na₂CO₃ in 100 ml of volumetric flask and then make up to mark with distilled water.

### Sample Procedure:

i. Take 1 g of sample in 100 ml conical flask and then add 10-15 ml of 70% MeOH (70 ml methanol: 30 ml water).
ii. Keep it hot plate for extraction at 95° C. for 1 hr.
iii. After 1 hr filter through whatman filter paper 1 and then make up to 25 ml of volumetric flask with 70% methanol.
iv. Then we take test tubes and add 1 ml of each sample then add 5 ml of folin ciocalteu's phenol reagent shake well.
v. Incubation for 5 mins.
vi. After 5 mins add 4 ml of 7.5% Na₂CO₃ mix well then keep it dark place incubation for 1 hr.
vii. Measure the absorbance at 765 nm.
viii. Standard take 1 ml of each sample (10 ppm-50 ppm) then add 5 ml phenol reagent shake well incubation for 5 mins then add 4 ml Na₂CO₃ mix well incubation for 1 hr in dark place.
ix. Check OD @765 nm.

Result: The amount of protein present in the given sample was provided in below table:

TABLE B
Total phenol content in Paddy grain samples

| Sr. | | Phenol Content |
|---|---|---|
| No. | Sample Name | (ppm) |
| 1. | Control - Farmer Practice* | 12.05 |
| 2. | Potassium formate + MN | 25.09 |
| 3. | Potassium diformate + MN | 26.89 |
| 4. | Potassium diformate | 17.96 |
| 5. | Potassium formate | 16.69 |
| 6. | Micronutrients | 18.22 |

*Farmer Practice - All kinds of N, P, K fertilizers and supplements
MN—Micronutrient

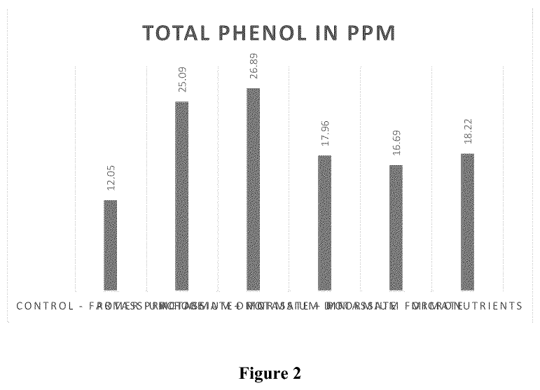

The values achieved in above table also demonstrated in the form of Figure. It is clear from above Table B and FIG. 2 provided below that the Composition comprising potassium formate (mono or di) and metal ions exhibits presence of higher amount of Phenol Content as compare to individual potassium formate (mono and di), individual metal ions/micronutrients and control.

### Example 11: Estimation of Total protein content by Lowry method

A. 2% Na₂Co₃ in 0.1 NaOH Preparation:
Dissolve 1 g of NaOH in 250 ml of volumetric flask and then make up to mark with distilled water. To the above solution add 5 g of Na₂co₃ mix well.

### B. 1% NAK Tartrate (Sodium Potassium Tartrate) Preparation:

Dissolve 1 g of NAK tartrate in 100 ml of volumetric flask and then make up to mark with distilled water.

### C. 0.5% CuSO4·5H2O (Copper Sulfate Pentahydrate):

Take 0.5 g of copper sulfate pent hydrate in 100 ml of volumetric flask and then make up to mark with distilled water.
Reagent 1: 192 ml of A, 4 ml of B, 4 ml of C
Reagent 2: Folin-Ciocalteu's phenol reagent preparation: 1 part of phenol reagent (2N) and 1 part of water
Bovine serum albumin (BSA) standard 1 mg/ml: Dissolve 100 mg of BSA in 100 ml of volumetric flask and then make up to mark with distilled water. Take 6 test tubes then add to the above solution each of 0.1, 0.2, 0.3, 0.4, 0.5, 0.6.

### Sample Procedure:

i. Take 1 g of sample in 25 ml of volumetric flask and then make up to mark with distilled water mix well.
ii. Then filter through whatman filter paper 1 we take test tubes and add 1 ml of each sample.
iii. Add 4.5 ml of reagent 1 and incubate for 10 mins.
iv. After incubation add 0.5 ml of reagent 2 and incubate for 30 mins.
v. Measure the absorbance at 660 nm and plot the standard graph.

The Analysis of protein estimation in grain samples is performed by Lowry method with UV Vis Spectro photo meter at 660 nm.

| | | | | | | Vol | | |
|---|---|---|---|---|---|---|---|---|
| | | | | | | of | | |
| | Conc of | | | | | folin- | | |
| | BSA | Vol of | Vol of | Vol of | | phenol | | |
| Sr. | STD | BSA | H2O | reagent | | reagent | | |
| No | (mg/ml) | (ml) | (ml) | 1 (ml) | | 2 (ml) | | |
| 1 | 16 ppm | 0.1 ml | 0.9 | 5 ml | Incubation | 4 ml | Incubation | OD @ |
| 2 | 33.3 ppm | 0.2 ml | 0.8 | 5 ml | for 10 mins | 4 ml | for 30 mins | 660 nm |
| 3 | 50 ppm | 0.3 ml | 0.7 | 5 ml | | 4 ml | | |
| 4 | 66.6 ppm | 0.4 ml | 0.6 | 5 ml | | 4 ml | | |
| 5 | 83.3 ppm | 0.5 ml | 0.5 | 5 ml | | 4 ml | | |
| 6 | 100 ppm | 0.6 ml | 0.4 | 5 ml | | 4 ml | | |
| 7 | Blank | 0 | 1 | 5 ml | | 4 ml | | |
| 8 | Sample | 0 | 1 | 5 ml | | | | |

### Calculations/Result:

The amount of protein present in the given sample was provided in below table:

TABLE C
Total Protein content in Paddy grain samples

| Sr. | | Total Protein |
|---|---|---|
| No. | Sample Name | content in ppm |
| 1. | Control - Farmer Practice* | 0.068 |
| 2. | Potassium formate + MN | 0.096 |
| 3. | Potassium diformate + MN | 0.097 |
| 4. | Potassium diformate | 0.084 |
| 5. | Potassium formate | 0.086 |
| 6. | Micronutrients | 0.089 |

*Farmer Practice - All kinds of N, P, K fertilizers and supplements
MN—Micronutrient

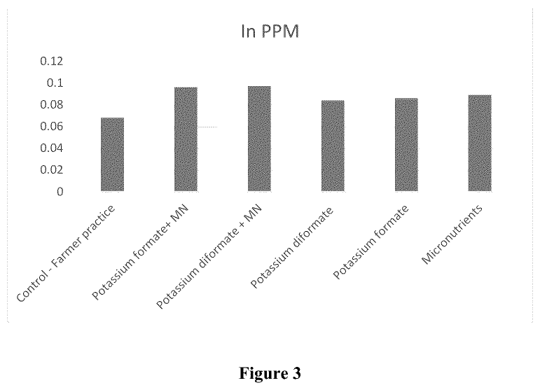

The values achieved in above table also demonstrated in the form of Figure. It is clear from above Table C and FIG. 3 provided below that the Composition comprising potassium formate (mono or di) and metal ions exhibits presence of higher amount of total protein content as compare to individual potassium formate (mono and di), individual metal ions/micronutrients and control.

### REFERENCES

ⁱhttps://www.scitechnol.com/plant/plant-metabolism.php
ⁱⁱhttps://www.chemicalbook.com/Article/Fertiliser-s-potassium-formate-potential.htm
ⁱⁱⁱhttps://www.frontiersin.org/articles/10.3389/fenvs.2016.00069/full#B124

1. A synergistic plant growth stimulant composition to improve the catalytic activity of metalloenzymes resulting into enhanced metabolic activities in plant system comprising:
a) potassium monoformate or potassium diformate in an amount of 1 to 20%; and
b) at least one metal compound in the form of metal oxides/ions or metal salts/complex in an amount of 0.1 to 50% of the total composition;
wherein the ratio of potassium monoformate or potassium diformate and metal ion compounds varies from 1:0.05 or 1:0.5 or 1:1.

2. The synergistic plant growth stimulant composition as claimed in claim 1, wherein said metal oxides/ions are selected from such as Copper (Cu²⁺), Zinc (Zn²⁺), Cobalt (Co²⁺), Nickel (Ni²⁺), Manganese (Mn²⁺), Molybdenum (Mo²⁺), Ferric/Ferrous (Fe^{3+/2+}), Selenium (Se⁴⁺), either alone or in any combination thereof.

3. The synergistic plant growth stimulant composition as claimed in claim 1, wherein said or metal salts/complex are selected from metal salts/complex such as calcium, potassium, copper, cobalt, zinc, iron, boron, manganese, magnesium, nickel, selenium, molybdenum, iodine, Copper sulphate pentahydrate, Zinc sulphate monohydrate, Ferrous sulphate heptahydrate, Manganese sulphate monohydrate, Magnesium sulphate anhydrous, Nickel Sulphate hexahydrate, Cobalt sulphate heptahydrate and Potassium iodide.

4. The synergistic plant growth stimulant composition as claimed in claim 1, wherein said composition optionally comprises primary or secondary nutrients and plant growth hormones.

5. The synergistic plant growth stimulant composition as claimed in claim 4, wherein said primary nutrients are selected from nitrogen, phosphorous or potassium and secondary nutrients are selected from silica, calcium, magnesium or sulphur, either alone or in any combination thereof.

6. The synergistic plant growth stimulant composition as claimed in claim 4; wherein the amount of primary or secondary nutrients used in the synergistic composition ranges from 0.1 to 50% of the total composition.

7. The synergistic plant growth stimulant composition as claimed in claim 4, wherein said plant growth hormones are selected from Gibberellic acid, melatonin, abscisic acid either alone or in any combination thereof in an amount of 0.05 to 10% of the total composition.

8. The synergistic plant growth stimulant composition as claimed in claim 1, wherein said composition further comprises calcium formate and boric acid in an amount of 125 to 500 gm of the total composition.

9. The synergistic plant growth stimulant composition as claimed in claim 1, wherein said composition further comprises iodine, hormones, additional nutritional products, growth stimulation agents, nitrogenous compounds with minerals, and minerals and trace metals.

10. The synergistic plant growth stimulant composition as claimed in claim 9, wherein said hormones are selected from auxin, cytokinin, gibberellic acid, brassinosteroids, ethylene, abscisic acid, salicylic acid and Jasmonic acid in a concentration ranging from 0.05% to 10% of the total composition.

11. The synergistic plant growth stimulant composition as claimed in claim 9, wherein said additional nutritional products and/or growth stimulation agents are selected from amino acid powders, and essential oils in a concentration ranging from 0.1 to 5%.

12. The synergistic plant growth stimulant composition as claimed in claim 9, wherein said minerals and trace metals are selected from Zn, Cu, Mn, Fe, Co, Ca, Mg, Mn and in the range of about 400 g/acre to 3000 g/acre.

13. The synergistic plant growth stimulant composition as claimed in claim 1, wherein said composition optionally furthers comprises additional inert ingredients including one or more of adjuvants, emulsifiers, thickeners, suspension agents, wetting agents, surfactant and filler and aqua filler material.

14. The synergistic plant growth stimulant composition as claimed in claim 13, wherein said adjuvants, emulsifiers, thickeners, suspension agents, wetting agents are present in an amount of 0.1 to 10% of the total composition.

15. The synergistic plant growth stimulant composition as claimed in claim 14, wherein said surfactant are selected from anionic, non-ionic and cationic surfactants, carboxy methyl cellulose (CMC), lignosulfonates and is present in an amount of 0.1 to 10% of total composition.

16. The synergistic plant growth stimulant composition as claimed in claim 1, wherein said composition is formulated in the form of powder, liquid, solutions, spray, gel or granules.

17. A process for the preparation of a synergistic plant growth stimulant composition according to claim 1, the process comprising:
a) blending active ingredients and adding surfactant and adjuvants to obtain a powder form;
b) mixing an aqua filler with the active ingredients to obtain a liquid form;
c) granulating the active ingredients with a filler material such as bentonite or dolomite to obtain a granule form;
d) dissolving the powder, liquid or granule form obtained in above step (a), (b) or (c) in water and applying on crops.

18. A method of improving the catalytic activity of metalloenzymes, results in enhanced metabolic activities in plant system by spraying synergistic plant growth stimulant composition comprising potassium monoformate or potassium diformate and metal ion compounds as claimed in claim 1 on leaves as foliar application or by mixing in soil as fertilizer application.

19. A synergistic plant growth stimulant composition comprising potassium monoformate or potassium diformate and metal ion compounds as claimed in claim 1, for improving the catalytic activity of metalloenzymes which result in enhanced metabolic activities in plant system thereby providing high yields and quality produce.

20. The synergistic plant growth stimulant composition as claimed in claim 5, wherein the amount of primary or secondary nutrients used in the synergistic composition ranges from 0.1 to 50% of the total composition.
